(19) United States
(12) Patent Application Publication
(10) Pub. No.: US 2024/0051618 A1
(43) Pub. Date: Feb. 15, 2024

(54) ATTACHMENT FOR SECURING A LOAD OF ELONGATED MEMBERS AGAINST A WALL SURFACE

(71) Applicant: ADAM FRANK CORLEY, WINNIPEG (CA)

(72) Inventor: ADAM FRANK CORLEY, WINNIPEG (CA)

(21) Appl. No.: 17/703,394

(22) PCT Filed: Oct. 5, 2020
(86) PCT No.: PCT/CA2020/051333

§ 371 Date: Mar. 24, 2022

Related U.S. Application Data
(60) Provisional application No. 62/910,536, filed on Oct. 4, 2019.

(51) Int. Cl. B62D 33/04; B60P 7/08

(52) U.S. Cl. CPC B62D 33/046; B60P 7/0807

(57) ABSTRACT

An apparatus for supporting a plurality of elongated members on a wall defining an upstanding wall surface comprises a sheet configured for mounting to the wall in substantially-planar upstanding orientation with one face disposed opposite to the wall surface, so as to be an inner face, and an opposite face of the sheet facing away from the wall, so as to be an outer face. The apparatus includes a plurality of holders each arranged to receive one of the elongated members in generally horizontal orientation and connected to the outer face of the sheet in an array forming at least one column across the sheet in which the holders are disposed in generally linear fashion one above the other between the upper and lower ends of the sheet so that the elongated members are supportable generally one above the other in horizontal orientation.

### FIELD OF THE INVENTION

The present invention relates to an apparatus for securing a plurality of elongated members against an upstanding wall surface which is particularly but not exclusively suited for use in a portable containment structure such as a highway transport trailer.

### BACKGROUND

In one example, when shipping an unassembled kitchen cabinet system for subsequent installation at a customer site, trim pieces of the kitchen cabinet system are packaged in elongated boxes separately of larger components of the kitchen cabinet system and are usually loosely loaded into a highway transport trailer without being fixedly secured. The loose loading of these packaged trim pieces causes them to shift inside the trailer during transport which may lead to damage upon collision with other items being shipped or with the interior of the trailer, or may cause the trim pieces to shift to a position from which they may fall by gravity out of the trailer when access doors of the trailer are eventually opened for unloading.

### SUMMARY OF THE INVENTION

According to one aspect of the invention there is provided an apparatus for supporting a plurality of elongated members on a wall defining an upstanding wall surface comprising:

a sheet extending longitudinally from a lower end to an upper end and having opposite inner and outer faces;

wherein the sheet is configured for mounting to the wall in substantially-planar upstanding orientation with the inner face disposed opposite to the wall surface and the outer face of the sheet facing away from the wall; and

a plurality of holders each arranged to receive one of the elongated members in generally horizontal orientation and connected to the outer face of the sheet in an array forming at least one column across the sheet in which the holders are disposed in generally linear fashion one above the other between the upper and lower ends of the sheet so that the elongated members are supportable generally one above the other in horizontal orientation.

In one arrangement, the sheet is flexible.

In one arrangement, the sheet is removably attachable to the wall.

In one arrangement, the holders are resiliently inwardly compressible so as to be arranged to confine movement of the elongated member received therein.

In one arrangement, each holder is in the form of a strap connected to the sheet so as to define with the outer face of the sheet a passageway through which a respective one of the elongated members can be passed.

In one arrangement, the column of the holders is formed by a common elongated strip of material extending longitudinally across the outer face of the sheet and arranged to define the holders at longitudinally spaced locations across the strip.

In one arrangement, the sheet extends between laterally opposite sides and the array of the holders includes a pair of laterally spaced apart columns on the outer face of the sheet so as to provide laterally opposite pairs of the holders through which each elongated member can be passed.

In one arrangement, the apparatus further includes a plurality of holders each arranged to receive one of the elongated members in generally horizontal orientation and connected to the inner face of the sheet.

In one arrangement, the sheet is configured for mounting to the wall by mounting devices configured for attaching to the wall and supported at the upper and lower ends of the sheet, wherein one of the mounting devices is carried by a stretchable linkage member operatively interconnecting said mounting device and the sheet at a corresponding one of the upper and lower ends.

In one arrangement, the mounting devices are configured for mating insertion into receptacles provided on the wall.

### BRIEF DESCRIPTION OF THE DRAWINGS

The invention will now be described in conjunction with the accompanying drawings in which:

FIG. 1 is a schematic elevational view of a first arrangement according to the present invention;

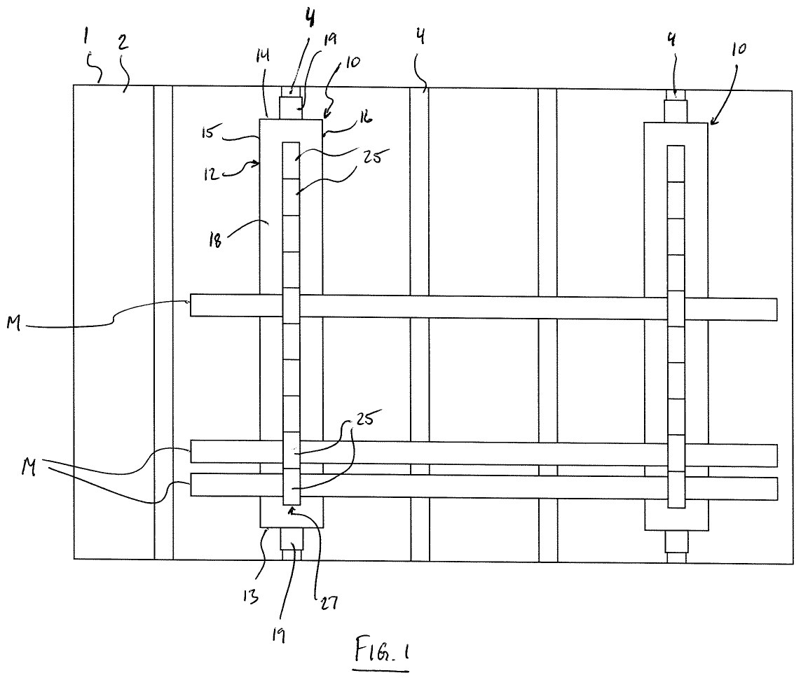

FIG. 2 is a schematic end view of a first arrangement according to the present invention; and

FIG. 3 is a schematic elevational view of a second arrangement according to the present invention;

FIG. 4 is a schematic end view of a third arrangement according to the present invention; and

FIG. 5 shows arrangements of the present inventions in use in a portable containment structure.

In the drawings like characters of reference indicate corresponding parts in the different figures.

### DETAILED DESCRIPTION

In the accompanying figures there is shown an apparatus 10 for supporting a plurality of elongated members M such as trim pieces on a wall 1 defining an upstanding wall surface 2.

The apparatus 10 comprises a sheet 12 extending longitudinally from a lower end 13 to an upper end 14, laterally between opposite sides 15, 16 and having opposite inner and outer faces 17, 18. The sheet 12 is configured for mounting to the wall 1 in substantially-planar upstanding orientation with the inner face 17 disposed opposite to the wall surface 2, so as to be facing same, and the outer face 18 of the sheet facing away from the wall. In the illustrated embodiment, a mounting arrangement 19 in the form of a pair of clips disposed at the opposite ends 13, 14 of the sheet and distinct therefrom is provided to facilitate mounting of the sheet to the wall. Where the wall is an upstanding wall of a portable containment structure such as that of a highway transport trailer, the mounting arrangement 19 can be arranged for mating with vertically extending tracks 4 in the wall 1. In other words, the apparatus 10 includes individual mounting devices 19, collectively defining the aforementioned mounting arrangement, which are configured for attaching to the wall and are supported at each one of the lower and upper ends 13, 14 of the sheet. More specifically, the mounting devices 19 are configured for removable mating insertion into receptacles 4A defined in a respective one of the tracks 4 provided on the wall 1.

The sheet 12 is flexible so as to be foldable on itself into a compacted storage condition when detached from the wall. Thus in its working condition attached to the wall 1 the sheet 12 is stretched taut so as to substantially define a plane which is parallel to the wall surface 2. In the illustrated arrangement, the sheet is made from webbing which is a tightly woven fabric material having woven synthetic fibers. In the working condition the sheet 12 is tensioned so as to provide a relatively rigid substrate for supporting weight of the elongated members M, as will be better appreciated shortly.

The apparatus further includes a plurality of holders 25 each arranged to receive one of the elongated members M in generally horizontal orientation and connected to the outer face 18 of the sheet in an array forming at least one column 27 across the sheet 12 in which the holders 25 are disposed in generally linear fashion one above the other between the upper and lower ends 14, 13 of the sheet so that the elongated members M are supportable generally one above the other in horizontal orientation.

The holders 25 are resiliently inwardly compressible so as to be arranged to confine movement of the elongated member received therein, particularly in a transverse direction of the member M itself towards and away from the sheet.

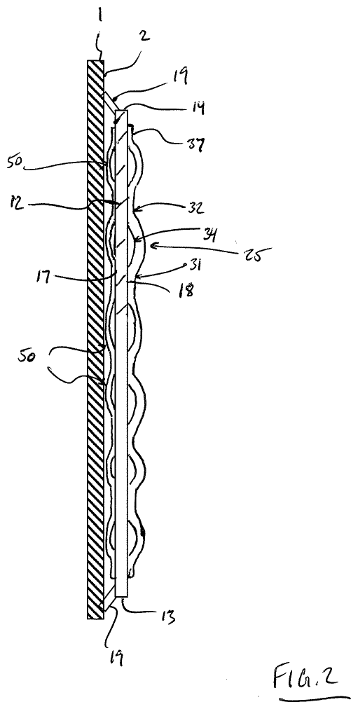

As more clearly shown in FIG. 2, each holder 25 is in the form of a strap connected to the sheet so as to define with the outer face 18 of the sheet a passageway 34 which is open at either end, through which a respective one of the elongated members M can be passed. That is, each holder 25 can be considered as a strap having opposite ends 31, 32 connected to the sheet 12, which may not be terminuses of the strap and therefore may be indistinct from an end of an adjacent one of the holder straps, and an intermediate portion 36 between the ends which is free from attachment to the sheet, where the passageway 34 is provided. The strap is elastic so as to provide resilient compression against the elongated member M passed therethrough to confine transverse movement of the member relative to the sheet 12. Thus to pass the elongated member M through the respective holder, the strap 25 specifically the free intermediate portion 36 thereof is stretched away from the outer face 18 of the sheet so as to provide a suitably sized opening to slidably insert the elongated member therethrough.

Still referring to FIG. 2, the column 27 of the holders is formed by a common elongated strip of material indicated at 37 extending longitudinally across the outer face 18 of the sheet and arranged to define the holders 25 at longitudinally spaced locations across the common strip. In this arrangement, the strip 37 is attached to the sheet 12 at spaced locations along the strip so as to provide a holder between each adjacent pair of attachment locations, providing a length of the strip which is free from the sheet 12.

The apparatus may further include a plurality of holders 50 each arranged to receive one of the elongated members M in generally horizontal orientation and connected to the inner face 17 of the sheet. In the first illustrated embodiment, both sets of holders on the inner and outer faces 17, 18 are formed by a common elastic strip fastened to the sheet at longitudinally spaced positions to provide a series of adjacent individual elastic straps stretchable away from the face of the sheet.

The sheet 12 is removably attachable to the wall by its mounting arrangement 19 so that the apparatus can be removed when not in use.

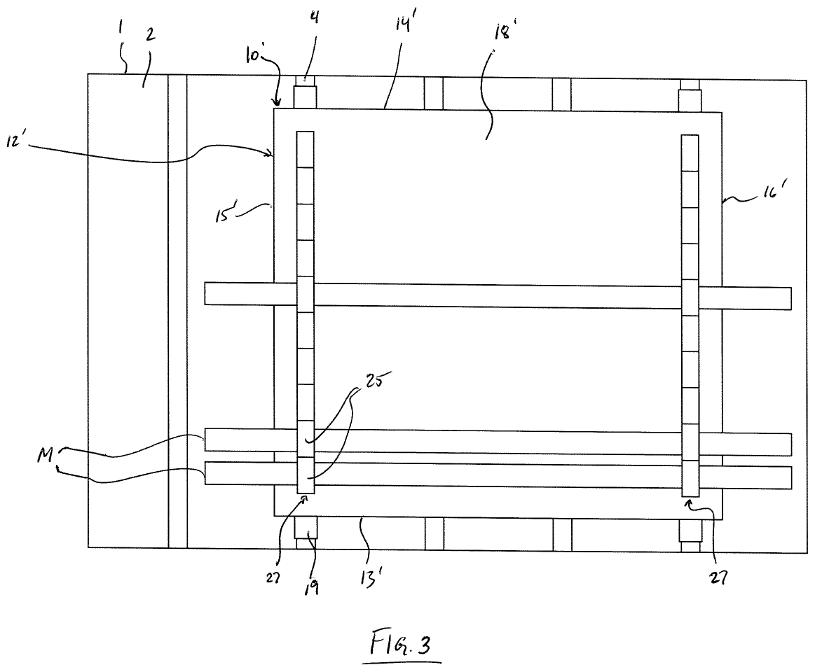

FIG. 3 shows another embodiment of the apparatus indicated at 10′ with a larger sheet 12′ defining an outer face 18′ with greater surface area between opposite ends 13′, 14′ and opposite sides 15′, 16′ than the elongated strip-like sheet 12 of the first embodiment, so as to provide space for an array of the holders including a pair of laterally spaced apart columns 27 on the outer face 18 of the sheet so as to provide laterally opposite pairs of the holders through which each elongated member M can be passed through. In comparison, the sheet of the first embodiment is in the form of an elongated strip of material providing a surface area suitable for supporting only one column of holders such that for longer members requiring support at spaced locations thereon a plurality of the apparatuses 10 can be employed.

Thus generally speaking the sheet 12 acts as a substrate for supporting the holders 25 and, when applicable those indicated at 50 also, in predetermined spatial relation to one another. The substrate 12 is mounted to the wall 1 so that the holders carrying the elongated members M are supported in generally fixed relation to the wall 1.

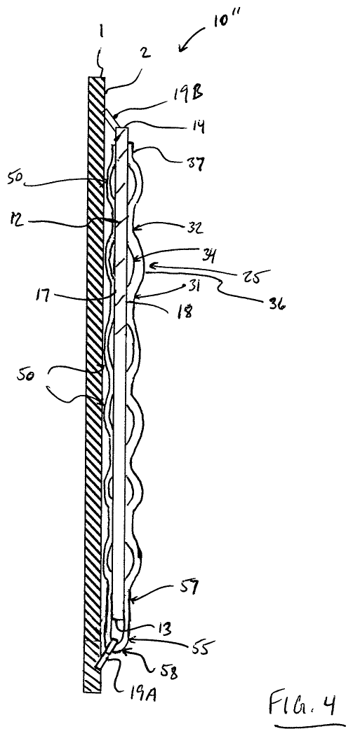

FIG. 4 shows another arrangement of the apparatus 10″ in which one mounting device 19A configured for attaching to the wall is carried by a stretchable linkage member 55 operatively interconnecting this mounting device and the sheet 12 at a corresponding one of the upper and lower ends, which in this case is the lower end 13. The linkage member 55 has a first end 57 which is affixed or otherwise attached in fixed relation to the sheet 12 and a free end 58, so as to be movable relative to the sheet 12, which is stretchable away from the lower end 13 and which carries the mounting device 19 on a linking element 59 such as a loop. Thus the linkage member 55 is tensionable by attaching the mounting device 19 carried on the free end 58 at a location on the wall 1 that is spaced from the lower end 13 of the sheet, so as to in turn tension the flexible sheet 12. In the illustrated embodiment, the linkage member 55 is in the form of an elastic strip connected at opposite ends thereof to the sheet 12, generally at the opposite faces 17, 18 to form a loop about the lower end 13. Furthermore, in this embodiment the loop is formed by the same strip of material forming the holders 25 and/or 50 for receiving the elongated members M. Another mounting device 19B at the upper end 14 of the sheet is mounted in generally fixed relation to the sheet 12.

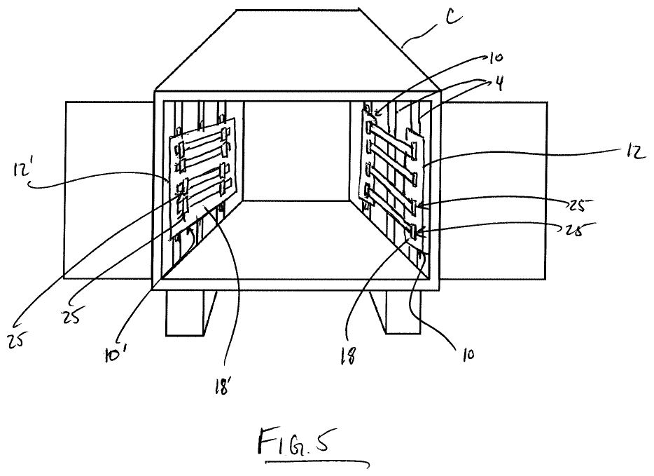

There is also disclosed herein a method of securing a load of separate elongated members M in a containment structure C shown in FIG. 5. The method comprises attaching to an upstanding interior wall 1 of the containment structure C a sheet-like substrate 12 or 12′ which carries on one of its faces such as 18, 18′ a plurality of holders arranged in at least one substantially-vertically extending column for receiving the elongated members. Then, the elongated members are located in the holders 25 such that the elongated members M are secured on the wall 1 one above the other each and in generally horizontal orientation.

The scope of the claims should not be limited by the preferred embodiments set forth in the examples but should be given the broadest interpretation consistent with the specification as a whole.

1. An apparatus for supporting a plurality of elongated members on a wall defining an upstanding wall surface comprising:
a sheet extending longitudinally from a lower end to an upper end and having opposite inner and outer faces;
wherein the sheet is configured for mounting to the wall in substantially-planar upstanding orientation with the inner face disposed opposite to the wall surface and the outer face of the sheet facing away from the wall; and
a plurality of holders each arranged to receive one of the elongated members in generally horizontal orientation and connected to the outer face of the sheet in an array forming at least one column across the sheet in which the holders are disposed in generally linear fashion one above the other between the upper and lower ends of the sheet so that the elongated members are supportable generally one above the other in horizontal orientation.

2. The apparatus of claim 1 wherein the sheet is flexible.

3. The apparatus of claim 1 wherein the sheet is removably attachable to the wall.

4. The apparatus of claim 1 wherein the holders are resiliently inwardly compressible so as to be arranged to confine movement of the elongated member received therein.

5. The apparatus of claim 1 wherein each holder is in the form of a strap connected to the sheet so as to define with the outer face of the sheet a passageway through which a respective one of the elongated members can be passed.

6. The apparatus of claim 1 wherein the column of the holders is formed by a common elongated strip of material extending longitudinally across the outer face of the sheet and arranged to define the holders at longitudinally spaced locations across the strip.

7. The apparatus of claim 1 wherein the sheet extends between laterally opposite sides and the array of the holders includes a pair of laterally spaced apart columns on the outer face of the sheet so as to provide laterally opposite pairs of the holders through which each elongated member can be passed.

8. The apparatus of claim 1 further including a plurality of holders each arranged to receive one of the elongated members in generally horizontal orientation and connected to the inner face of the sheet.

9. The apparatus of claim 1 wherein the sheet is configured for mounting to the wall by mounting devices supported at the upper and lower ends of the sheet, wherein one of the mounting devices is carried by a stretchable linkage member operatively interconnecting said mounting device and the sheet at a corresponding one of the upper and lower ends.

10. The apparatus of claim 9 wherein the mounting devices are configured for mating insertion into receptacles provided on the wall.

11. A method of securing a load of separate elongated members in a containment structure comprising:
attaching to an upstanding interior wall of the containment structure a sheet-like substrate which carries on one of its faces a plurality of holders arranged in at least one substantially-vertically extending column for receiving the elongated members;
locating the elongated members in the holders such that the elongated members are secured against the wall one above the other and in generally horizontal orientation.
